(19) United States
(12) Patent Application Publication
(10) Pub. No.: US 2026/0319604 A1
(43) Pub. Date: Oct. 15, 2026

(54) INPUT DEVICE

(71) Applicant: ALPS ALPINE CO., LTD., Tokyo (JP)

(72) Inventors: Shunsuke SATO, Miyagi (JP); Yohei ROKKASHO, Miyagi (JP)

(21) Appl. No.: 19/694,290

(22) Filed: Jun. 1, 2026

Related U.S. Application Data
(63) Continuation of application No. PCT/JP2024/041043, filed on Nov. 19, 2024.

(30) Foreign Application Priority Data
Dec. 4, 2023 (JP) 2023-204601

(51) Int. Cl. G06F 3/0362; G06F 3/039

(52) U.S. Cl. CPC G06F 3/0362; G06F 3/0393

(57) ABSTRACT

An input device includes an electrostatic sensor configured to detect an operation position of an operator on an operation surface; and a dial unit configured to be fixed to the operation surface. The dial unit includes a base portion configured to be fixed to the operation surface, an operation portion configured to be operated by the operator, and a projection provided on a side of the operation portion where the operation surface is to be situated, and configured to be detectable by the electrostatic sensor and to be movable integrally with the operation portion. The operation portion is supported to be rotatable about an imaginary rotation axis perpendicular to the operation surface with respect to the base portion and supported to be slidable in a direction crossing the imaginary rotation axis in a plan view.

### CROSS-REFERENCE TO RELATED APPLICATIONS

This application is a continuation application of International Application No. PCT/JP2024/041043, filed on Nov. 19, 2024, and designated the U.S., which is based upon and claims priority to Japanese Patent Application No. 2023-204601, filed on Dec. 4, 2023, the entire contents of which are incorporated herein by reference.

### BACKGROUND

### 1. Field of the Invention

The present disclosure relates to an input device.

### 2. Description of the Related Art

Conventionally, an input display device including: a touch panel enabling touch input by touching a screen; an operation device disposed on the screen of the touch panel and configured to realize a real operational sensation by utilizing a touch input function of the touch panel; and a controller configured to generate a normal function in response to either touch input to the touch panel or operation of the operation device, is known. In this input display device, when the operation of the operation device and the touch input to the screen are performed simultaneously, the controller is configured to perform an extended function different from the normal function when the operation device is operated alone. An operation member is overlaid on the screen of the touch panel, moves on the screen, and covers a large area of the screen (see, for example, Japanese Patent Application Publication No. 2016-206930).

### SUMMARY

An input device according to an embodiment of the present disclosure includes: an electrostatic sensor configured to detect an operation position of an operator on an operation surface; and a dial unit configured to be fixed to the operation surface. The dial unit includes a base portion configured to be fixed to the operation surface, an operation portion configured to be operated by the operator, and a projection provided on a side of the operation portion where the operation surface is to be situated, and configured to be detectable by the electrostatic sensor and to be movable integrally with the operation portion. The operation portion is supported to be rotatable about an imaginary rotation axis perpendicular to the operation surface with respect to the base portion and supported to be slidable in a direction crossing the imaginary rotation axis in a plan view.

### BRIEF DESCRIPTION OF DRAWINGS

FIG. 1 is a view illustrating an example of a configuration of an input device according to an embodiment of the present disclosure.

FIG. 2 is a view illustrating an example of a configuration of a dial unit of the input device according to the embodiment.

FIG. 3 is a view illustrating an example of an exploded configuration of the dial unit of the input device of the embodiment.

FIG. 4 is a view illustrating an example of a configuration of an XZ cross section passing through a center axis of the dial unit of the input device of the embodiment.

FIG. 5 is a view illustrating an example of a lower ring of the dial unit of the embodiment in a plan view.

FIG. 6 is a view illustrating an example of a slider of the dial unit of the embodiment in a plan view.

FIG. 7 is a graph illustrating an example of XY coordinates of four centroids detected by an MCU of the input device of the embodiment.

FIG. 8 is a graph illustrating an example of XY coordinates of four centroids after a rotation operation detected by the MCU of the input device of the embodiment.

### DETAILED DESCRIPTION OF THE DISCLOSURE

The operation member of the conventional input display device is overlaid on the screen of the touch panel, moves on the screen, and covers a large area of the screen, resulting in poor usability.

In view of this, it is an object of the present disclosure to provide an input device with good usability.

Hereinafter, embodiments to which an input device of the present disclosure is applied will be described. In the following, the same components are denoted by the same reference signs, and thus duplicate descriptions may be omitted.

The following description will be made based on an XYZ coordinate system. A direction (X-direction) parallel to an X-axis, a direction (Y-direction) parallel to a Y-axis, and a direction (Z-direction) parallel to a Z-axis are orthogonal to each other. The XYZ coordinate system is an example of an orthogonal coordinate system. Viewing an XY-plane is referred to as a plan view. In the following, the length, thickness, and the like of each component may be exaggerated to facilitate understanding of a configuration. Also, the terms parallel, right angle, orthogonal, horizontal, vertical, up-down, and the like are permitted to deviate to a degree that does not impair the effects of the embodiments.

### Embodiments

### Input Device 10

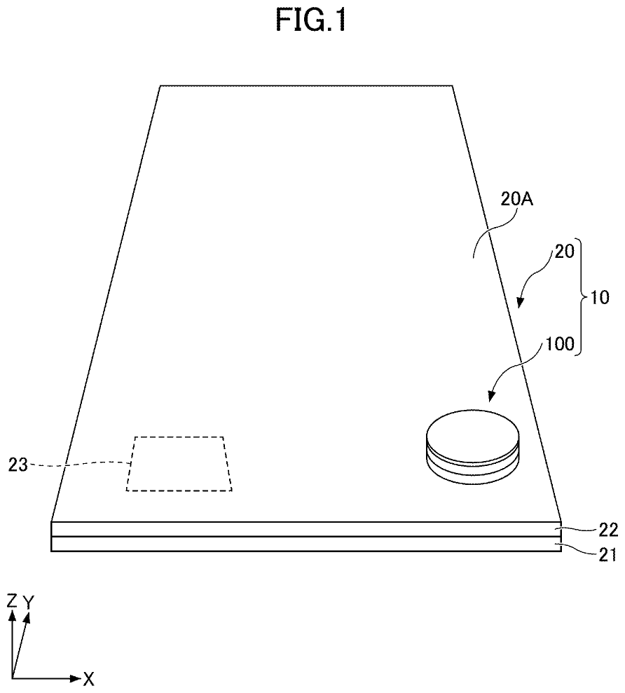

FIG. 1 is a view illustrating an example of a configuration of an input device 10. The input device 10 includes a touch panel 20 and a dial unit 100. The input device 10 can be used by attaching the dial unit 100 to an operation surface 20A of the touch panel 20 with double-sided tape or the like. Here, as an example, a configuration of the input device 10 including both the touch panel 20 and the dial unit 100 will be described. However, the input device 10 may be configured by the dial unit 100 alone without including the touch panel 20.

### Touch Panel 20

The touch panel 20 includes a display panel 21, an electrostatic sensor 22, and an MCU (Micro Controller Unit) 23. The MCU 23 is an example of an operation determination unit. A transparent top panel is provided on the electrostatic sensor 22, and the upper surface of the top panel is the operation surface 20A of the touch panel 20. Therefore, the electrostatic sensor 22 is provided on the rear side of the operation surface 20A. The electrostatic sensor 22 is overlaid on the display panel 21. The display panel 21 and the electrostatic sensor 22 are connected to the MCU 23 and controlled by the MCU 23.

The display panel 21 is, as an example, a liquid crystal panel, an OLED (Organic Light Emitting Diode) panel, or the like. The electrostatic sensor 22 includes transparent electrodes arranged in the X-direction and the Y-direction. The MCU 23 is configured to, based on an electrostatic capacitance of the electrostatic sensor 22, detect XY coordinates of a position at which an operation body, such as a hand or the like, touches the operation surface 20A, or of a position at which the operation body approaches the operation surface 20A.

The XY coordinates of the position at which the operation body approaches the operation surface 20A are XY coordinates of the operation body in a state in which the operation body approaches the operation surface 20A. The state in which the operation body approaches the operation surface 20A is a state in which the operation body does not contact the operation surface 20A but becomes close to the operation surface 20A, and the MCU 23 can detect the XY coordinates of the operation body based on the electrostatic capacitance of the electrostatic sensor 22. The input device 10 may include, instead of the touch panel 20, a touch pad including the electrostatic sensor 22 alone without the display panel 21.

### Dial Unit 100

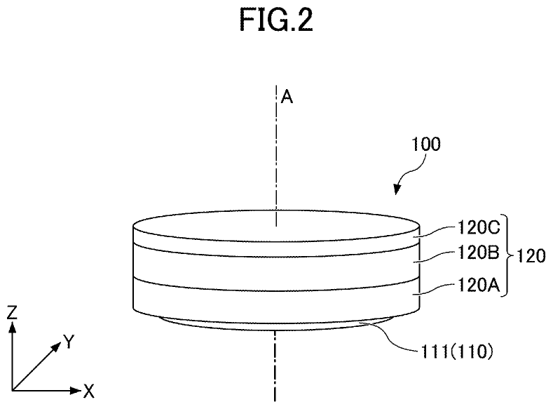

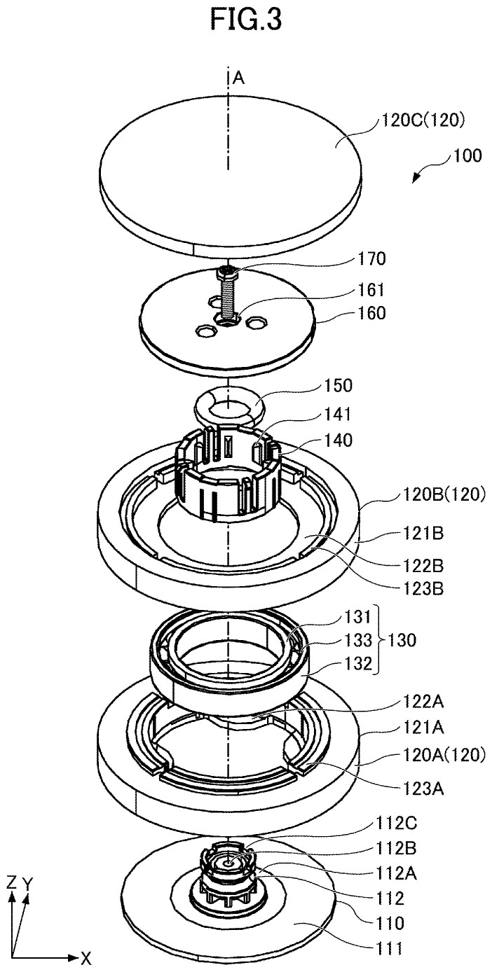

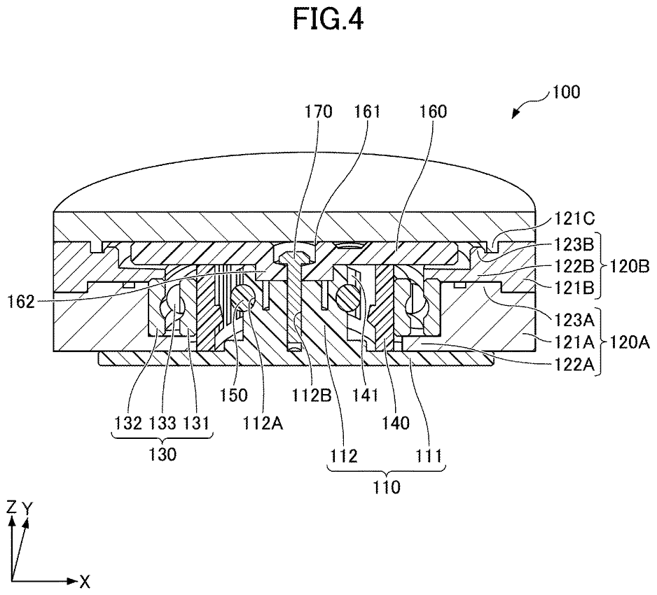

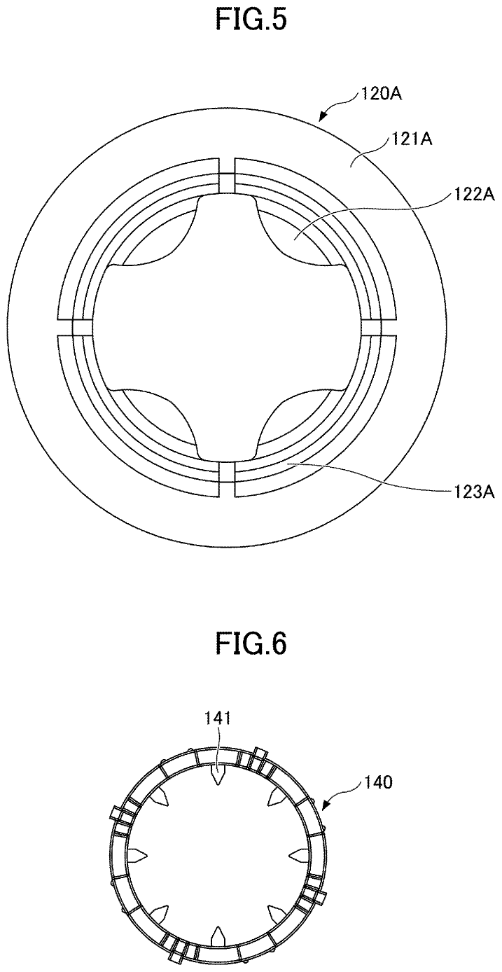

The dial unit 100 will be described with reference to FIGS. 2, 3, 4, 5, and 6, in addition to FIG. 1. FIG. 2 is a view illustrating an example of a configuration of the dial unit 100. FIG. 3 is a view illustrating an example of an exploded configuration of the dial unit 100. FIG. 4 is a view illustrating an example of a configuration of an XZ cross section passing through a center axis of the dial unit 100. FIG. 5 is a view illustrating an example of a lower ring 120A of the dial unit 100 of the embodiment in a plan view. FIG. 6 is a view illustrating an example of a slider 140 of the dial unit 100 of the embodiment in a plan view. Note that the center axis of the disk-shaped dial unit 100 is an imaginary rotation axis serving as a rotation center of the disk-shaped operation portion 120. In FIGS. 2 and 3, this imaginary rotation axis is shown by a chain line as an imaginary rotation axis A.

The dial unit 100 includes a holder 110, an operation portion 120, a bearing 130, a slider 140, an O-ring 150, a cover 160, and a screw 170. The holder 110 is an example of a base portion. The slider 140 is an example of a sliding member. The O-ring 150 is an example of an elastic member.

The dial unit 100 is a device configured to, in a state of being attached to the operation surface 20A as illustrated in FIG. 1, rotate the operation portion 120 about the imaginary rotation axis A in the XY-plane, i.e., a rotation operation, and slide the operation portion 120 in the XY-plane in a direction parallel to the XY-plane, i.e., a sliding operation. The possible sliding operation includes, as an example, a sliding operation to slide the operation portion 120 in any direction having an angle with respect to the X-axis and the Y-axis, in addition to the sliding operation to slide the operation portion 120 in the direction parallel to the X-axis and the Y-axis.

Also, when the operator performs the rotation operation and the sliding operation of the operation portion 120, the operation body, such as an operator's hand or the like, touches the operation portion 120 or approaches the operation portion 120. As an example, the MCU 23 can detect, based on the electrostatic capacitance of the electrostatic sensor 22, the positions of four projections 122A of the operation portion 120, and the rotation angle of the operation portion 120. That is, the MCU 23 can detect, based on the electrostatic capacitance of the electrostatic sensor 22, the rotation angle of the rotation operation of the operation portion 120, and an operation direction and an operation amount of the sliding operation. Details of this will be described below.

For example, when the touch panel 20 is an operation panel of an in-vehicle electronic device, as an example, the rotation operation enables an adjustment of temperature and airflow of an air conditioner, an adjustment of an audio volume, a selection of a radio station, or the like, and the sliding operation enables an adjustment, such as movement of a cursor, movement of a display area of the display panel 21, or the like. Also, the dial unit 100 can be similarly used even when the touch panel 20 is used for an application other than the operation panel of an in-vehicle electronic device.

### Holder 110

The holder 110 includes: a disk-shaped base 111 including a lower surface fixed to the operation surface 20A; and a support 112 extending upward from the center of an upper surface of the base 111. The lower surface of the base 111 of the holder 110 is fixed to the operation surface 20A with double-sided tape or the like. Thus, the holder 110 is fixed to the operation surface 20A.

The support 112 is a substantially columnar portion. The support 112 includes, in an intermediate portion of the support 112 in an up-down direction, a groove-like recess 112A in which the side surface of the support 112 is recessed radially inward over the entire circumference. The recess 112A has an arc cross-sectional shape, and the O-ring 150 is fitted into the recess 112A so as not to be displaced in the up-down direction. Also, a screw hole 112B is provided at the center of the upper surface of the support 112, and four cutouts 112C are provided in a circumferential wall enclosing the screw hole 112B at equal intervals in the circumferential direction. The screw hole 112B is provided on the center axis of the support 112 (an imaginary rotation axis A in an initial state) and a screw 170 is fastened into the screw hole 112B. Also, the cutouts 112C are engaged with engaging portions 162 (see FIG. 4) projecting from the lower surface of the cover 160, thereby functioning to align the cover 160 to be screw-fastened and prevent rotation together with a screw head.

### Operation Portion 120

The operation portion 120 is divided into three, i.e., a lower ring 120A, an intermediate ring 120B, and an upper cover 120C. The lower ring 120A and the intermediate ring 120B are annular (ring-shaped) members having the imaginary rotation axis A as a center axis, and the upper cover 120C is a disk-shaped member having the imaginary rotation axis A as a center axis.

The lower ring 120A, the intermediate ring 120B, and the upper cover 120C are formed of a metal as an example, and are formed of aluminum as an example. Since the operation portion 120 is formed of a metal, such as aluminum or the like, the operation portion 120 is capacitively coupled to the electrostatic sensor 22.

The operation portion 120 is a portion that is directly touched by the operation body, such as the operator's hand or the like. In the dial unit 100, the operation portion 120 is formed of a metal because the MCU 23 can readily detect that the operation body is touching the operation portion 120 based on the electrostatic capacitance of the electrostatic sensor 22. However, even if the operation portion 120 is formed of a non-metal material, when the MCU 23 can detect that the operation body is touching the operation portion 120 based on the electrostatic capacitance of the electrostatic sensor 22 with the high sensitivity of the electrostatic sensor 22, the operation portion 120 may be formed of a non-metal material, such as a resin or the like.

### Lower Ring 120A

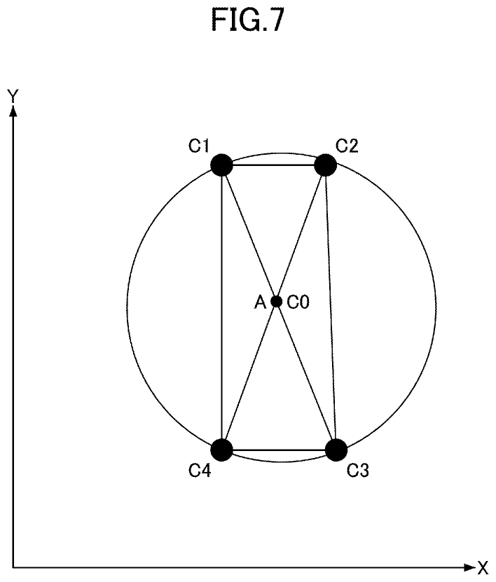

The lower ring 120A includes a ring portion 121A, the projections 122A, and an engaging portion 123A. The ring portion 121A is an annular (ring-shaped) portion, and is provided with the four projections 122A (see FIG. 5) projecting radially inward from the lower end of the inner surface. As an example, each of the projections 122A projects radially inward in an arc shape from the inner surface of the ring portion 121A in a plan view. The four projections 122A are arranged along the circumferential direction. The arrangement of the four projections 122A will be described below with reference to FIG. 7.

The engaging portion 123A is an annular ridge projecting upward from the upper surface of the ring portion 121A at a position of the upper surface of the ring portion 121A that is closer to the inner edge. The engaging portion 123A includes, as an example, an annular ridge divided in the circumferential direction. When the intermediate ring 120B is engaged with the lower ring 120A, the inner surface of a downward projecting annular portion of a ring portion 121B of the intermediate ring 120B is engaged with the outer surface of the annular ridge of the engaging portion 123A. Also, the upper surface of the ridge is contacted by the lower surface of a flange 122B projecting radially inward from the inner surface of the ring portion 121B of the intermediate ring 120B. Thus, the lower ring 120A and the intermediate ring 120B are electrically connected to each other, and are fixed in a state in which movement is restricted in radial and up-down directions. Further, the lower surface of the intermediate ring 120B is provided with projections (not shown) that are inserted into the divided portions of the annular ridge. Thus, the lower ring 120A and the intermediate ring 120B are fixed in a state in which movement is restricted in a rotation direction.

The outer surface of an outer ring 132 of a bearing 130, which is formed by an inner ring 131, the outer ring 132, and a ball 133, is fitted into the inner surface of the lower ring 120A. The lower surface of the bearing 130 is supported by the four projections 122A of the lower ring 120A so as not to be displaced in the Z-direction. The upper surface of the outer ring 132 is pressed by the flange 122B of the intermediate ring 120B so as not to be displaced in the Z-direction. That is, the bearing 130 is restricted in the up-down direction to be positioned between the projection 122A of the lower ring 120A and the flange 122B of the intermediate ring 120B. Note that the outer surface of the outer ring 132 of the bearing 130 and the inner surface of the lower ring 120A are firmly fitted into each other so as not to rotate relative to each other.

### Intermediate Ring 120B

The intermediate ring 120B includes the ring portion 121B, the flange 122B, and an engaging portion 123B. The ring portion 121B is an annular (ring-shaped) portion. As described above, the ring portion 121B is provided with the flange 122B projecting radially inward from the inner surface. As an example, the flange 122B is provided annularly over the entire inner surface of the ring portion 121B. The engaging portion 123B is an annular ridge projecting upward from the upper surface of the flange 122B. The engaging portion 123B is divided in the circumferential direction. The intermediate ring 120B is fitted into the upper surface of the lower ring 120A in a state in which the bearing 130 is fitted into the inner surface of the lower ring 120A.

Also, when the upper cover 120C is mounted on the intermediate ring 120B, the inner surface of the annular engaging portion 121C (see FIG. 4), in a plan view, of the lower surface of the upper cover 120C is engaged with the outer surface of the engaging portion 123B. The lower surface of the upper cover 120C contacts the upper surface of the ring portion 121B. The intermediate ring 120B and the upper cover 120C are electrically connected to each other, and are fixed in a state in which movement is restricted in the radial and up-down directions. Further, the lower surface of the annular engaging portion 121C of the upper cover 120C is provided with projections (not shown) that are inserted into the divided portions of the annular ridge of the engaging portion 123B. Thus, the intermediate ring 120B and the upper cover 120C are fixed in a state in which movement is restricted in a rotation direction.

### Upper Cover 120C

The upper cover 120C is a disk-shaped member provided at the uppermost portion of the dial unit 100. As described above, the bearing 130 is mounted between the lower ring 120A and the intermediate ring 120B. A unit in which the slider 140 is fitted into the inner ring 131 of the bearing 130 is assembled. The O-ring 150 and the slider 140, formed into the unit, are sequentially assembled in the holder 110, followed by fixing the cover 160 with the screw 170 and finally mounting the upper cover 120C on the intermediate ring 120B. In a state of being electrically connected to the intermediate ring 120B, the upper cover 120C is supported to be integrally rotatable with respect to the holder 110 as the operation portion 120 along with the lower ring 120A and the intermediate ring 120B.

### Bearing 130

As described above, the bearing 130 includes the inner ring 131, the outer ring 132, and the ball 133. The inner ring 131 is an example of an inner-diameter-side member, and the outer ring 132 is an example of an outer-diameter-side member. The bearing 130 is, as an example, formed of a metal. As an example, the inner ring 131 is fitted into the outer surface of the substantially cylindrical slider 140, and rotates integrally with the slider 140. Also, the outer ring 132 is fitted into the inner surface of the lower ring 120A of the operation portion 120, and rotates integrally with the lower ring 120A. Therefore, the operation portion 120 is rotatable with respect to the slider 140 via the bearing 130. Note that the bearing 130 may be restricted from moving upward by a snap claw included in the slider 140. Also, the configuration of the component to be fitted into the bearing 130 is not limited to the above configuration, and may be a configuration in which the inner ring 131 is fitted into the operation portion 120 and the outer ring 132 is fitted into the slider 140. That is, the bearing 130 may be at any position as long as it is provided partway through a driving force transmission path between the operation portion 120 and the slider 140.

### Slider 140

The slider 140 is a substantially cylindrical member formed of a dielectric material, and includes a plurality of engaging portions 141 projecting radially inward from the inner surface. As an example, the engaging portion 141 is a tubular portion including a substantially triangular tip at the inner end in the radial direction in a plan view, and extending in the up-down direction. As an example, the plurality of engaging portions 141 are provided at equal intervals along the circumferential direction of the inner surface of the slider 140 such that the direction from the tip toward the center axis is eight directions coinciding with sliding operation directions (see FIG. 6).

The slider 140 is fitted into the outer side of the O-ring 150. In this state, the inner ends of the plurality of engaging portions 141 in the radial direction slightly intrude into and contact the outer edge of the O-ring 150 fitted into the recess 112A of the support 112 of the holder 110. The outer edge of the O-ring 150 is the outermost portion of the O-ring 150 in a plan view. In this state, even if the rotation operation is performed on the dial unit 100, the slider 140 remains in place and does not rotate about the imaginary rotation axis A. This is because a strong frictional force between the engaging portions 141 and the O-ring 150 becomes a rotational load.

In this state, the center axis (imaginary rotation axis A) of the substantially cylindrical shape of the slider 140 coincides with the center axis of the holder 110. With respect to the sliding operation, this state is an initial state in which the slider 140 does not slide. When the slider 140 receives the sliding operation performed on the dial unit 100 in the initial state, i.e., a force to move in the radial direction, the tips of the engaging portions 141, arranged to coincide with the direction of the sliding operation, press the outer edge of the O-ring 150 toward the center of the O-ring, and thus the O-ring 150 elastically deforms toward the center. The pointed tips of the engaging portion 141 used for the pressing can achieve a reduced contact area with the O-ring 150. Compared to performing pressing in a large contact area, the pressing load is concentrated to increase the amount of elastic deformation. This can increase a deviation amount by which the center axis of the slider 140 deviates from the center axis of the holder 110 in the XY-plane, thereby reliably detecting the movement caused by the sliding operation. That is, the slider 140 is slidable relative to the holder 110 in a direction parallel to the XY-plane. In the present embodiment, the slider is slidable in eight directions at equal intervals of an angle of 45 degrees. This is by no means a limitation. The direction parallel to the XY-plane includes any direction having an angle with respect to the X-axis and the Y-axis, in addition to the direction parallel to the X-axis and the Y-axis. Thus, the operation portion 120 attached to the slider 140 via the bearing 130 is slidable integrally with the slider 140 in the direction parallel to the XY-plane.

In the present embodiment, a configuration in which the inner edge of the O-ring 150 is supported by the support 112 of the holder 110 and the slider 140 is in contact with the outer edge of the O-ring 150 will be described. However, a configuration in which the outer edge of the O-ring 150 is supported by the support 112 of the holder 110 and the slider 140 is in contact with the inner edge of the O-ring 150 is possible.

### O-Ring 150

The O-ring 150 is a rubber member that is annular in a plan view. The inner circumferential portion of the O-ring 150 is fitted into the recess 112A of the support 112 of the holder 110, and the plurality of engaging portions 141 of the slider 140 are engaged with the outer circumferential portion of the O-ring 150. Here, a configuration of using the annular O-ring 150 having a circular cross-sectional shape will be described. However, the cross-sectional shape of the O-ring 150 may be a shape other than the circular shape, e.g., an elliptical annular shape, a rectangular annular shape, a triangular annular shape, or a shape of a polygon having five or more sides. Also, the overall shape may also be any shape other than the annular shape.

### Cover 160

The cover 160 is a disk-shaped member formed of a dielectric material, and includes a screw hole 161 at the center in a plan view. The screw hole 161 penetrates through the cover 160 in the Z-direction. The lower surface of the cover 160 includes four engaging portions 162 (see FIG. 4) for engagement with four cutouts 112C provided in the upper end of the support 112 of the holder 110. The engaging portions 162 are provided in a cross shape on the lower surface of the cover 160 to enclose the screw hole 161. Also, the lower surface of the cover 160 restricts an upward movement of the slider 140, supports the slider 140 to be slidable between the lower surface of the cover 160 and the disk-shaped base 111 of the holder 110, and guides the slider 140 such that the sliding operation is performed smoothly.

### Screw 170

The screw 170 is allowed to pass through the screw hole 161 of the cover 160, and screw-fastened to the screw hole 112B of the support 112 of the holder 110. Thus, the lower ring 120A, the intermediate ring 120B, the bearing 130, the slider 140, and the O-ring 150 exist between the cover 160 and the holder 110.

Among them, the slider 140, the bearing 130, and the operation portion 120 are slidable integrally with respect to the holder 110 through elastic deformation of the O-ring 150, as described above. Also, as described above, the operation portion 120 is rotatable with respect to the slider 140 by the bearing 130. Note that, although the screw 170 is formed, as an example, of a metal in the present embodiment, the screw 170 may be formed of any material, such as a resin or the like, as long as the material satisfies a required strength.

### Detection of Rotation Angle and Sliding Amount of Operation Portion 120

When the MCU 23 detects the XY coordinates of the four projections 122A based on the electrostatic capacitance of the electrostatic sensor 22, it is possible to detect the XY coordinates of the operation portion 120. More specifically, the detection may be performed in the following manner.

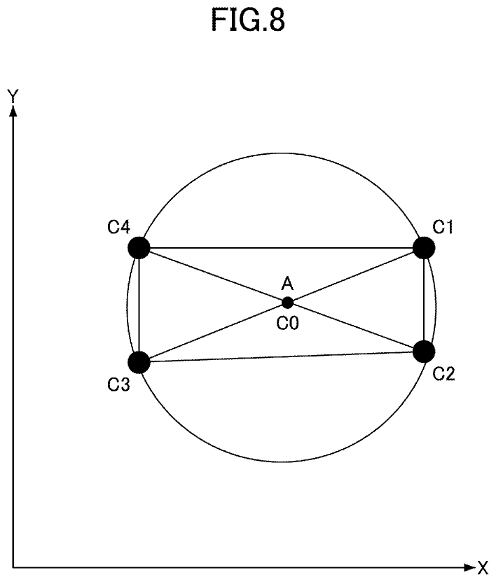

FIG. 7 is a graph illustrating an example of XY coordinates of centroids C1 to C4 of the four projections 122A detected by the MCU 23. FIG. 8 is a graph illustrating an example of XY coordinates of the centroids C1 to C4 of the four projections 122A after the rotation operation detected by the MCU 23. Although the centroid of a mass is obtained based on a distribution of mass, the centroid as used herein is a theoretical point determined according to a predetermined calculation based on a distribution of electrostatic capacitance, instead of mass, larger than the surrounding electrostatic capacitance detected in accordance with the semicircular shape of the projection 122A. Therefore, a point at which an electrostatic capacitance is larger than the surrounding electrostatic capacitance is not necessarily directly detected as a point at the centroids C1 to C4. Also, a point at which an electrostatic capacitance is larger than the surrounding electrostatic capacitance may be simply used as the centroid if such a point is detectable. Alternatively, the centroid may be a point representing the position of the XY coordinates of the projection 122A. Since portions of the lower end of the lower ring 120A where the four projections 122A are present have an electrostatic capacitance larger than that of portions where the four projections 122A are absent, the MCU 23 can calculate the XY coordinates of the centroid of each projection 122A based on the distribution of the electrostatic capacitance of the electrostatic sensor 22. Further, as an example, the MCU 23 calculates the position of a center C0 of the XY coordinates of the centroids C1 to C4 of the four projections 122A as the XY coordinates of the operation portion 120 according to a predetermined calculation based on the XY coordinates of the centroids C1 to C4.

Note that the MCU 23 may detect the XY coordinates of recesses located between the four projections 122A at the lower end of the lower ring 120A, instead of the XY coordinates of the four projections 122A. Since the electrostatic capacitance of the recess is lower than the electrostatic capacitance of the projection 122A, the MCU 23 can detect the XY coordinates of the recesses located between the four projections 122A based on the electrostatic capacitance of the electrostatic sensor 22. In this manner, even if the MCU 23 detects the XY coordinates of the recess at the lower end of the lower ring 120A, the lower end of the lower ring 120A includes a projection between the recesses next to each other.

Also, as illustrated in FIGS. 7 and 8, the four projections 122A are provided such that the XY coordinates of the centroids C1 to C4 of the four projections 122A detected by the MCU 23 are positioned at the vertices of a rectangle disposed, in a plan view, in point symmetry about a center that is the imaginary rotation axis A. Therefore, the position of the center C0 theoretically coincides with the position of the imaginary rotation axis A in a plan view.

Also, the MCU 23 can detect the rotation angle of the operation portion 120 based on the XY coordinates of the centroids of the four projections 122A. As an example, as illustrated in FIGS. 7 and 8, it is assumed that the centroids C1 to C4 are arranged clockwise in a plan view, and that the side between the centroids C1 and C2 and the side between the centroids C3 and C4 correspond to two short sides of the rectangle, and the side between the centroids C2 and C3 and the side between the centroids C4 and C1 correspond to two long sides of the rectangle.

In such a case, as an example, it is assumed that the MCU 23 determines that the rotation angle of the operation portion 120 is 0 degrees in an initial state in which the short sides are parallel to the X-axis and the long sides are parallel to the Y-axis, as illustrated in FIG. 7. The angle formed by the short sides is calculated according to a predetermined calculation based on the XY coordinates of the centroids C1 and C2 and the XY coordinates of the centroids C3 and C4, and the angle formed by the long sides is calculated according to a predetermined calculation based on the XY coordinates of the centroids C2 and C3 and the XY coordinates of the centroids C4 and C1.

As an example, when the centroids C1 to C4 are rotated by 90 degrees clockwise in a plan view in the state as illustrated in FIG. 7, the state in which the short sides are parallel to the X-axis and the long sides are parallel to the Y-axis changes to the state as illustrated in FIG. 8, i.e., the state in which the short sides are parallel to the Y-axis and the long sides are parallel to the X-axis. Therefore, the MCU 23 calculates the XY coordinates of the centroids C1 to C4 after the rotation based on the electrostatic capacitance of the centroids C1 to C4 after the rotation detected by the electrostatic sensor 22, thereby calculating the angles formed by the respective sides after the rotation based on the calculated XY coordinates of the centroids C1 to C4. When the angles formed by the respective sides are changed by 90 degrees, it is possible to determine that the rotation angle of the operation portion 120 is 90 degrees. Also, as another method, when the XY coordinates of the centroids C1 to C4 and the XY coordinates of the center C0 after the rotation are compared with the respective XY coordinates of the initial state and calculated according to a predetermined calculation, it is possible to determine that the XY coordinates of the center C0 are not moved from the initial state and that the line connecting the center C0 and each of the centroids C1 to C4 (half of a diagonal line) is rotated by 90 degrees clockwise about the center C0. This applies to the case in which the rotation angle is between 0 degrees and 90 degrees, and to the case in which the rotation angle is between 90 degrees or more and less than 180 degrees. Also, this applies to the case in which the operation portion 120 is rotated counterclockwise. Note that, when the rotation operation is continuously performed over 180 degrees or more, the MCU 23 can detect the rotation angle and the rotation direction of the rotation operation by continuously counting at predetermined short timings at which the rotation angle becomes 180 degrees or less.

The sliding amount and the sliding direction during the sliding operation can be detected by comparing the XY coordinates of the center C0 in the initial state calculated from the XY coordinates of the centroids C1 to C4 with the XY coordinates of the center C0 calculated from the XY coordinates of the centroids C1 to C4 after sliding. This is applicable to the sliding operation in any direction in any amount of movement.

As described above, since the XY coordinates of the centroids C1 to C4 of the four projections 122A are located at the vertices of the rectangle disposed, in the plan view, in point symmetry about the imaginary rotation axis A, the MCU 23 can readily calculate the position of the center C0 of the centroids C1 to C4 of the plurality of projections 122A, and can accurately determine a rotation angle of less than 180 degrees, a rotation direction, and a moving direction of the sliding operation. By detecting the XY coordinates and the rotation angle of the operation portion 120, the MCU 23 can determine a type of operation performed on the operation portion 120. For example, when the touch panel 20 is an operation panel of an in-vehicle electronic device, it is possible to, as an example, operate an air conditioner, an audio device, or the like by the rotation operation and the sliding operation.

Also, for example, when the XY coordinates of the four projections 122A cannot be detected based on the electrostatic capacitance of the electrostatic sensor 22, but the XY coordinates of the three projections 122A can be detected, the MCU 23 may detect the rotation angle and the sliding amount in the following manner. For example, the MCU 23 may store, in an internal memory, positional relationship data representing the positional relationship of the XY coordinates of the four projections 122A, estimate the XY coordinates of the four projections 122A based on the detected XY coordinates of three projections 122A and the positional relationship data, and determine a type of operation performed on the operation portion 120 based on the estimated XY coordinates of the four projections 122A, thereby detecting the rotation angle and the sliding amount.

For example, when the XY coordinates of only three projections 122A can be detected due to the influence of foreign matter or the like between the MCU 23 and the electrostatic sensor 22, the XY coordinates of the four projections 122A can be complementarily determined using the positional relationship data, thereby detecting the rotation angle and the sliding amount.

### Effects

The input device 10 includes the electrostatic sensor 22 configured to detect the operation position of the operator on the operation surface, and the dial unit 100 configured to be fixed to the operation surface 20A. The dial unit 100 includes the holder 110 (base portion) configured to be fixed to the operation surface 20A, the operation portion 120 configured to be operated by the operator, and the projection 122A provided on the side of the operation portion 120 where the operation surface 20A is to be situated, and configured to be detectable by the electrostatic sensor 22 and to be movable integrally with the operation portion 120. The operation portion is supported to be rotatable about the imaginary rotation axis A perpendicular to the operation surface 20A with respect to the holder 110 and supported to be slidable in the direction crossing the imaginary rotation axis A in the plan view. Therefore, the rotation operation and the sliding operation performed on the operation portion 120 of the dial unit 100 fixed to the operation surface 20A can be detected based on the electrostatic capacitance of the electrostatic sensor 22. Since the dial unit 100 is fixed to the operation surface 20A, usability is good.

Therefore, it is possible to provide the input device 10 with good usability.

Also, the O-ring 150 (elastic member) deformable in the direction crossing the imaginary rotation axis A in the plan view and configured to support the operation portion 120 with respect to the holder 110 may be included. During the sliding operation, the O-ring 150 (elastic member) is deformed in the direction crossing the imaginary rotation axis A to enable the operation portion 120 to slide.

Also, the slider 140 (sliding member) engageable with the outer edge or the inner edge of the O-ring 150 may be further included. The sliding member is slidable in the direction crossing the imaginary rotation axis A in the plan view with respect to the holder 110 and configured to support the operation portion 120 to be rotatable with respect to the holder 110. Thus, it is possible to switch between the rotation operation and the sliding operation of the operation portion 120 in a simple configuration.

Also, the bearing 130 provided between the slider 140 and the operation portion 120 may be further included. The bearing 130 includes the inner ring 131 (inner-diameter-side member) and the outer ring 132 (outer-diameter-side member). One of the inner ring 131 or the outer ring 132 is supported by the slider 140, and another of the inner ring 131 or the outer ring 132 may rotate integrally with the operation portion 120. By providing the bearing 130 between the slider 140 and the operation portion 120, the operation portion 120 is smoothly rotatable with respect to the slider 140 to enable the smooth rotation operation.

Also, the MCU 23 (operation determination portion) configured to detect the plurality of operation positions based on the electrostatic capacitance of the electrostatic sensor 22 and including the positional relationship data indicating the positional relationship of the plurality of operation positions may be further included. The MCU 23 is further configured to, in a case in which not all the plurality of operation positions are detectable, determine a type of operation performed on the operation portion 120 based on the detected operation positions and the positional relationship data. For example, in a case in which the XY coordinates of only three projections 122A can be detected due to the influence of foreign matter or the like, the XY coordinates of the four projections 122A can be complementarily determined using the positional relationship data, thereby detecting the rotation angle and the sliding amount.

Also, the plurality of the projections 122A may be provided. The plurality of the projections 122A are provided at the positions of the vertices of the rectangle that is disposed, in the plan view, in point symmetry about the center that is the imaginary rotation axis A. The center positions of the plurality of the projections 122A can be readily calculated, and the rotation angle of less than 180 degrees, the rotation direction, and the moving direction of the sliding operation can be accurately determined.

Also, the elastic member may be a rubber ring. Thus, it is possible to provide the input device 10 having a simple configuration, good assembleability, and good space efficiency.

The input device 10 includes the dial unit 100 configured to be fixed to the operation surface 20A overlaid on the electrostatic sensor 22. The dial unit 100 includes the holder 110 configured to be fixed to the operation surface 20A, the operation portion 120 configured to be operated by the operator who operates the operation surface 20A, and the projection 122A provided on a side of the operation portion 120 where the operation surface 20A is to be situated, and configured to be movable integrally with the operation portion 120. The operation portion 120 is supported to be rotatable about the imaginary rotation axis A perpendicular to the operation surface 20A with respect to the holder 110 and supported to be slidable in the direction crossing the imaginary rotation axis A in the plan view. Therefore, the rotation operation and the sliding operation performed on the operation portion 120 of the dial unit 100 fixed to the operation surface 20A can be detected based on the electrostatic capacitance of the electrostatic sensor 22. Since the dial unit 100 is fixed to the operation surface 20A, usability is good.

Therefore, it is possible to provide the dial unit 100 with good usability.

Although the input devices of exemplary embodiments of the present disclosure have been described above, the present disclosure is not limited to the specifically disclosed embodiments, and various modifications and alterations are possible without departing from the scope of the claims.

According to the present disclosure, it is possible to provide an input device with good usability.

What is claimed is:

1. An input device, comprising:
an electrostatic sensor configured to detect an operation position of an operator on an operation surface; and
a dial unit configured to be fixed to the operation surface, wherein
the dial unit includes
a base portion configured to be fixed to the operation surface,
an operation portion configured to be operated by the operator, and
a projection provided on a side of the operation portion where the operation surface is to be situated, and configured to be detectable by the electrostatic sensor and to be movable integrally with the operation portion, and
the operation portion is supported to be rotatable about an imaginary rotation axis perpendicular to the operation surface with respect to the base portion and supported to be slidable in a direction crossing the imaginary rotation axis in a plan view.

2. The input device according to claim 1, further comprising:
an elastic member deformable in the direction crossing the imaginary rotation axis in the plan view and configured to support the operation portion with respect to the base portion.

3. The input device according to claim 2, further comprising:
a sliding member that is engageable with an outer edge or an inner edge of the elastic member, and the sliding member is slidable in the direction crossing the imaginary rotation axis in the plan view with respect to the base portion and configured to support the operation portion to be rotatable with respect to the base portion.

4. The input device according to claim 3, further comprising:
a bearing provided between the sliding member and the operation portion, wherein
the bearing includes an inner-diameter-side member and an outer-diameter-side member,
one of the inner-diameter-side member or the outer-diameter-side member is supported by the sliding member, and
another of the inner-diameter-side member or the outer-diameter-side member rotates integrally with the operation portion.

5. The input device according to claim 1, further comprising:
an operation determination portion configured to detect a plurality of operation positions based on an electrostatic capacitance of the electrostatic sensor, and including positional relationship data indicating a positional relationship of the plurality of operation positions, wherein
the operation determination portion is further configured to, in a case in which not all the plurality of operation positions are detectable, determine a type of operation performed on the operation portion based on the detected operation positions and the positional relationship data.

6. The input device according to claim 1, wherein
a plurality of the projections are provided, and
the plurality of the projections are provided at positions of vertices of a rectangle that is disposed, in the plan view, in point symmetry about a center that is the imaginary rotation axis.

7. The input device according to claim 2, wherein
the elastic member is a rubber ring.

8. An input device, comprising:
a dial unit configured to be fixed to an operation surface overlaid on an electrostatic sensor, wherein
the dial unit includes
a base portion configured to be fixed to the operation surface,
an operation portion configured to be operated by the operator, and
a projection provided on a side of the operation portion where the operation surface is to be situated, and configured to be detectable by the electrostatic sensor and to be movable integrally with the operation portion, and
the operation portion is supported to be rotatable about an imaginary rotation axis perpendicular to the operation surface with respect to the base portion and supported to be slidable in a direction crossing the imaginary rotation axis in a plan view.
